(19) United States
(12) Patent Application Publication
(10) Pub. No.: US 2026/0064051 A1
(43) Pub. Date: Mar. 5, 2026

(54) FIXING DEVICE AND IMAGE FORMING SYSTEM USING THE SAME

(71) Applicant: FUJIFILM BUSINESS INNOVATION CORP., Tokyo (JP)

(72) Inventors: Mitsuhiro MATSUMOTO, Kanagawa (JP); Satoshi HASEBE, Kanagawa (JP); Masahito SHIKATA, Kanagawa (JP); Kosuke YAMADA, Kanagawa (JP); Toru INOUE, Kanagawa (JP)

(73) Assignee: FUJIFILM BUSINESS INNOVATION CORP., Tokyo (JP)

(21) Appl. No.: 19/036,297

(22) Filed: Jan. 24, 2025

(30) Foreign Application Priority Data
Sep. 5, 2024 (JP) 2024-153463

(51) Int. Cl. G03G 15/20

(52) U.S. Cl. CPC G03G 15/205; G03G 15/2017; G03G 15/2064

(57) ABSTRACT

A fixing device includes: a heating fixing unit that is rotatable and includes a heat source; a belt-like transport fixing unit that is rotatably provided as a result of being tightly stretched on the heating fixing unit and that transports a medium having an unfixed image formed thereon while contacting a surface of the medium on which the unfixed image is formed; a pressurizing fixing unit that is rotatable and is disposed to face the heating fixing unit so as to sandwich the transport fixing unit therebetween and that applies pressure so as to form a fixing area between the pressurizing fixing unit and the heating fixing unit, the fixing area being an area where the unfixed image is fixed; a cooling unit that cools the transport fixing unit, the cooling unit being disposed in a transport region of the transport fixing unit for the medium so as to contact a back side of the transport fixing unit, the cooling unit being disposed at a position farther downstream than the fixing area in a transport direction of the medium; and a driving controller that executes drive control during a standby mode to cause the transport fixing unit to perform idling rotation to repeat a forward rotation operation and a reverse rotation operation so that a portion of the transport fixing unit including a contact area where the transport fixing unit contacts the heating fixing unit and an area of the transport fixing unit which has been heated by the heating fixing unit and which has not yet reached a cooling area of the cooling unit contacts the heating fixing unit, the standby mode being a mode in which power supply to the heat source of the heating fixing unit is interrupted or reduced.

### CROSS-REFERENCE TO RELATED APPLICATIONS

This application is based on and claims priority under 35 USC 119 from Japanese Patent Application No. 2024-153463 filed Sep. 5, 2024.

### BACKGROUND

### (i) Technical Field

The present disclosure relates to a fixing device and an image forming system using the same.

### (ii) Related Art

As an example of a fixing device of the related art, the fixing device disclosed in Japanese Patent No. 5386904 (exemplary embodiment and FIG. 4) is known.

If an endless fixing belt is sandwiched and pressurized immediately after being heated, wrinkles are likely to occur. This publication discloses an image forming apparatus including a fixing device that addresses this issue. In this fixing device, before the endless fixing belt is heated, it is rotated in the reverse direction, and after it is heated, it is rotated in the forward direction, so as to prolong the time before the heated portion of the endless fixing belt is pressurized, thereby reducing the occurrence of wrinkles.

### SUMMARY

Aspects of non-limiting embodiments of the present disclosure relate to a fixing device and an image forming system using the same in which, at the time of fixing an unfixed image on a medium by heating and pressurizing a belt-like transport fixing unit and then by cooling it, the transport fixing unit is driven to perform idling rotation while suppressing a temperature drop of a heated portion of the transport fixing unit and a heating fixing unit during a standby mode in which power supply to the heating fixing unit is interrupted or reduced.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including: a heating fixing unit that is rotatable and includes a heat source; a belt-like transport fixing unit that is rotatably provided as a result of being tightly stretched on the heating fixing unit and that transports a medium having an unfixed image formed thereon while contacting a surface of the medium on which the unfixed image is formed; a pressurizing fixing unit that is rotatable and is disposed to face the heating fixing unit so as to sandwich the transport fixing unit therebetween and that applies pressure so as to form a fixing area between the pressurizing fixing unit and the heating fixing unit, the fixing area being an area where the unfixed image is fixed; a cooling unit that cools the transport fixing unit, the cooling unit being disposed in a transport region of the transport fixing unit for the medium so as to contact a back side of the transport fixing unit, the cooling unit being disposed at a position farther downstream than the fixing area in a transport direction of the medium; and a driving controller that executes drive control during a standby mode to cause the transport fixing unit to perform idling rotation to repeat a forward rotation operation and a reverse rotation operation so that a portion of the transport fixing unit including a contact area where the transport fixing unit contacts the heating fixing unit and an area of the transport fixing unit which has been heated by the heating fixing unit and which has not yet reached a cooling area of the cooling unit contacts the heating fixing unit, the standby mode being a mode in which power supply to the heat source of the heating fixing unit is interrupted or reduced.

### BRIEF DESCRIPTION OF THE DRAWINGS

Exemplary embodiments of the present disclosure will be described in detail based on the following figures, wherein:

FIG. 1A illustrates an overview of an image forming system including a fixing device that incorporates an exemplary embodiment of the disclosure;

FIGS. 1B and 1C illustrate an example of an idling rotation operation of a transport fixing unit performed under the control of a driving controller shown in FIG. 1A;

FIG. 2 illustrates the overall configuration of an image forming system according to a first exemplary embodiment;

FIG. 3A illustrates the major part of a second fixing unit according to the first exemplary embodiment;

FIG. 3B is a sectional view illustrating a transport fixing belt shown in FIG. 3A;

FIG. 4A illustrates a special sheet for a photographic image used as an example of a medium;

FIG. 4B illustrates a state in which a toner image is fixed on the special sheet;

FIG. 4C illustrates a state in which a toner image is fixed on plain paper, which is an example of a medium;

FIG. 5 illustrates a control system of the second fixing unit according to the first exemplary embodiment;

FIG. 6 is a flowchart illustrating drive control processing for the second fixing unit according to the first exemplary embodiment;

FIGS. 7A through 7D schematically illustrate an idling rotation operation of the second fixing unit during a standby mode based on the drive control processing shown in FIG. 6;

FIG. 8 is a flowchart illustrating drive control processing for the second fixing unit according to a modified example of the first exemplary embodiment;

FIGS. 9A through 9D schematically illustrate an idling rotation operation of the second fixing unit during the standby mode based on the drive control processing shown in FIG. 8;

FIG. 10 illustrates the major part of a second fixing unit according to a second exemplary embodiment;

FIG. 11 is a flowchart illustrating drive control processing for the second fixing unit according to the second exemplary embodiment;

FIGS. 12A through 12D schematically illustrate an idling rotation operation of the second fixing unit during the standby mode based on the drive control processing shown in FIG. 11;

FIG. 13A is a graph illustrating a temperature change of a heating fixing roller of a second fixing unit according to a first example and that of a first comparative example during the standby mode; and

FIG. 13B is a graph illustrating a temperature drop of the heating fixing roller of the second fixing unit according to the first example and that of the first comparative example when the wait time is ten seconds and thirty seconds.

### DETAILED DESCRIPTION

### Overview of Exemplary Embodiment

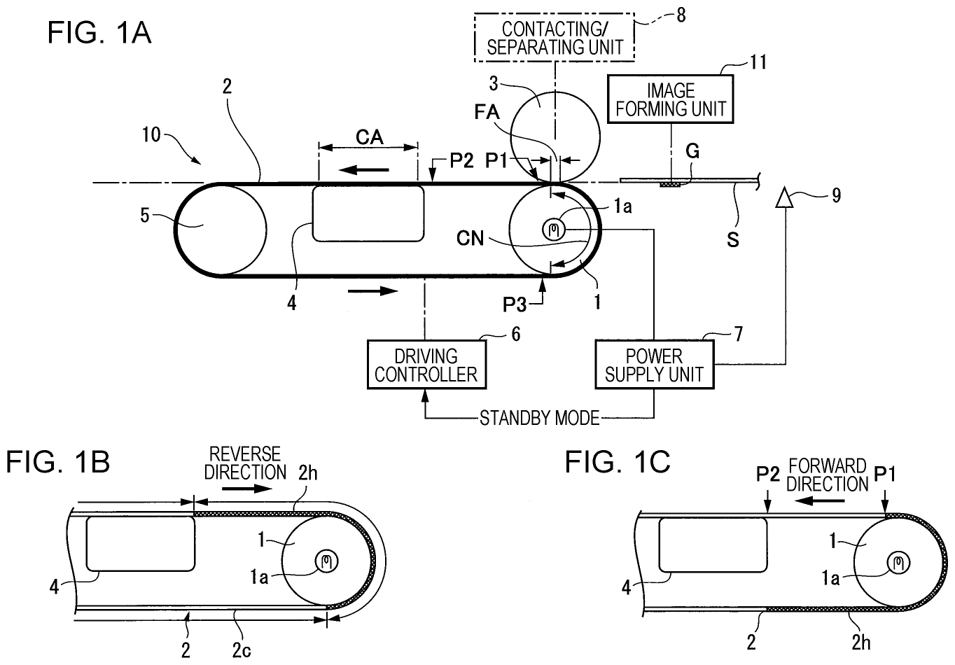

FIG. 1A illustrates an overview of an image forming system including a fixing device which incorporates an exemplary embodiment of the disclosure.

The image forming system shown in FIG. 1A includes an image forming unit 11 and a fixing device 10. The image forming unit 11 forms an image G, which is not yet fixed (hereinafter such an image will be called an unfixed image G), on a medium S. The fixing device 10 fixes the unfixed image G formed on the medium S.

In this example, the fixing device 10 heats and pressurizes the medium S having the unfixed image G held thereon and then cools it so as to fix the unfixed image G onto the medium S. The fixing device 10 includes a heating fixing unit 1, a belt-like transport fixing unit 2, a pressurizing fixing unit 3, a cooling unit 4, and a driving controller 6. The heating fixing unit 1 is rotatable and includes a heat source 1a. The transport fixing unit 2 is rotatably provided as a result of being tightly stretched on the heating fixing unit 1 and transports the medium S while contacting a surface of the medium S on which an image is formed. The pressurizing fixing unit 3 is rotatable and is disposed to face the heating fixing unit 1 so as to sandwich the transport fixing unit 2 therebetween. The pressurizing fixing unit 3 applies pressure so as to form a fixing area FA between the pressurizing fixing unit 3 and the heating fixing unit 1. The cooling unit 4 cools the transport fixing unit 2. The cooling unit 4 is disposed in a transport region of the transport fixing unit 2 for the medium S so as to contact the back side of the transport fixing unit 2. The cooling unit 4 is located at a position farther downstream than the fixing area FA in the transport direction of the medium S. During a standby mode in which power supply to the heat source 1a of the heating fixing unit 1 is interrupted or reduced, the driving controller 6 executes drive control to cause the transport fixing unit 2 to perform idling rotation to repeat a forward rotation operation and a reverse rotation operation so that a portion including a contact area CN where the transport fixing unit 2 contacts the heating fixing unit 1 and a portion of the transport fixing unit 2 which has been heated by the heating fixing unit 1 and which has not yet reached a cooling area CA of the cooling unit 4 contacts the heating fixing unit 1.

In this example, a power supply unit 7 supplies power to the heat source 1a of the heating fixing unit 1. The power supply unit 7 interrupts or reduces power supply to the heat source 1a of the heating fixing unit 1 during the standby mode.

The transport fixing unit 2 is tightly stretched on the heating fixing unit 1 and a separator 5, as illustrated in FIG. 1A. The separator 5 is located farther downstream than the cooling unit 4 in the transport direction of the medium S and is disposed at a position at which it separates the medium S from the transport fixing unit 2. The transport fixing unit 2 may be provided in a different manner from that illustrated in FIG. 1A. For example, another member, which is not shown, may be added to tightly support the transport fixing unit 2.

The fixing device 10 of the exemplary embodiment configured as described above may be built in an image forming apparatus including the image forming unit 11 that forms the unfixed image G. Alternatively, the fixing device 10 may be built in a postprocessing device, which is different from an image forming apparatus, and may be formed as an image forming system including multiple units.

The heating fixing unit 1 includes a heating fixing roller, for example. The heat source 1a may be built in the heating fixing unit 1 or may be externally provided. The transport fixing unit 2 includes a belt-like member. The belt-like member may be constituted by an endless film made of a thermosetting polyimide resin. In order to obtain a high-gloss image, such as a photographic image, a highly smooth coating layer may be applied onto the surface of the endless film. The pressurizing fixing unit 3 may have a desired shape such as a roller-like shape or a belt-like shape as long as it can pressurize the medium S so as to form the fixing area FA between the pressurizing fixing unit 3 and the heating fixing unit 1. If necessary, the pressurizing fixing unit 3 may include a heat source, which is not shown. The pressurizing fixing unit 3 may include a contacting/separating unit 8 that shifts the pressurizing fixing unit 3 from a contact position to a non-contact position during the standby mode. The contact position is a position at which the pressurizing fixing unit 3 contacts the transport fixing unit 2. The non-contact position is a position at which the pressurizing fixing unit 3 is separated from the transport fixing unit 2.

A wide range of devices can be used for the cooling unit 4 if they can cool the transport fixing unit 2 by contacting the back side of the transport fixing unit 2 within a medium transport area. One of the major examples of the cooling unit 4 is a heat dissipating unit that dissipates absorbed heat, such as a heat sink.

During the standby mode, in one example, the driving controller 6 performs control to interrupt power supply to the heat source 1a of the heating fixing unit 1, and, in another example, the driving controller 6 performs control to reduce power supply to the heat source 1a of the heating fixing unit 1

For example, when performing warming-up between the fixing device 10 of this example and another device, mutually exclusive control is executed for power supply to these devices. In this case, when warming up another device, the fixing device 10 enters the standby mode and power supply to the heat source 1a of the heating fixing unit 1 is interrupted. In this manner, the fixing device 10 is applicable to a case based on mutually exclusive control. However, the fixing device 10 is also applicable to another type of case which does not use mutually exclusive control. During the standby mode, therefore, in one example, power supply to the heat source 1a of the heating fixing unit 1 is interrupted, and in another example, power supply to the heat source 1a of the heating fixing unit 1 is reduced.

The driving controller 6 causes the transport fixing unit 2 to perform idling rotation during the standby mode in this example. The driving controller 6 executes this drive control in a specific manner.

“Idling rotation” in this example refers to that the transport fixing unit 2 repeatedly performs a forward rotation operation and a reverse rotation operation so that a predetermined portion of the transport fixing unit 2 contacts the heating fixing unit 1. The predetermined portion is a portion 2h (see FIG. 1B) of the transport fixing unit 2 that is heated by the heating fixing unit 1 (which will also be called the heated portion 2h). More specifically, the predetermined portion is a portion including a contact area CN where the transport fixing unit 2 contacts the heating fixing unit 1 and an area of the transport fixing unit 2 which has been heated by the heating fixing unit 1 and has not yet reached a cooling area CA of the cooling unit 4. This idling rotation operation of the transport fixing unit 2 is performed in order to suppress a temperature drop of the heating fixing unit 1, which is caused by a portion 2c cooled by the cooling unit 4 (which will also be called the cooled portion 2c).

Typical examples and other examples of the fixing device according to an exemplary embodiment will now be described below.

In one typical example, during the standby mode in which power supply to the heating fixing unit 1 is interrupted or reduced, the driving controller 6 performs the following drive control as illustrated in FIG. 1B. The driving controller 6 stops the forward rotation of the transport fixing unit 2 and causes it to start idling rotation in the reverse direction.

After the transport fixing unit 2 has started idling rotation in the reverse direction, the driving controller 6 stops the reverse rotation of the transport fixing unit 2 when the portion 2c cooled by the cooling unit 4 has reached a first position P1 and then causes the transport fixing unit 2 to start idling rotation in the forward direction, as illustrated in FIG. 1C. As the first position P1, any suitable position may be selected if it is a position at which the cooled portion 2c of transport fixing unit 2 has not yet reached the contact area CN.

After the transport fixing unit 2 has started idling rotation in the forward direction, the driving controller 6 stops the forward rotation of the transport fixing unit 2 when the portion 2h heated by the heating fixing unit 1 has reached a second position P2 and causes the transport fixing unit 2 to start idling rotation in the reverse direction, as illustrated in FIG. 1B. As the second position P2, any suitable position may be selected if it is a position at which the heated portion 2h of the transport fixing unit 2 has not yet reached the cooling area CA of the cooling unit 4. In this manner, thereafter, the driving controller 6 causes the transport fixing unit 2 to repeatedly perform idling rotation in the forward direction and in the reverse direction between the first position P1 and the second position P2.

In another typical example of the driving controller 6, after causing the transport fixing unit 2 to start idling rotation in the forward direction, the driving controller 6 performs the following drive control. As shown in FIG. 1A, a position before the position at which the cooled portion 2c of the transport fixing unit 2 reaches the contact area CN is set to a third position P3. In this example, the driving controller 6 stops the forward rotation of the transport fixing unit 2 when the cooled portion 2c of the transport fixing unit 2 has reached the third position P3 and causes the transport fixing unit 2 to start idling rotation in the reverse direction. In this manner, thereafter, the driving controller 6 causes the transport fixing unit 2 to repeatedly perform idling rotation in the forward direction and in the reverse direction between the first position P1 and the third position P3.

In a typical example, the driving controller 6 cancels the standby mode started by the power supply unit 7 in the following manner, as illustrated in FIG. 1A. A position detector 9 is disposed on the farther upstream side than the fixing area FA in the transport direction of the medium S and detects the position of the leading end or the trailing end of the medium S in the transport direction of the medium S. Based on a detection result of the position detector 9, the driving controller 6 cancels the standby mode and causes the power supply unit 7 to start supplying power to the heating fixing unit 1.

Typical exemplary embodiments and other exemplary embodiments of the fixing device based on the above-described exemplary embodiment will now be described below with reference to the accompanying drawings.

### First Exemplary Embodiment

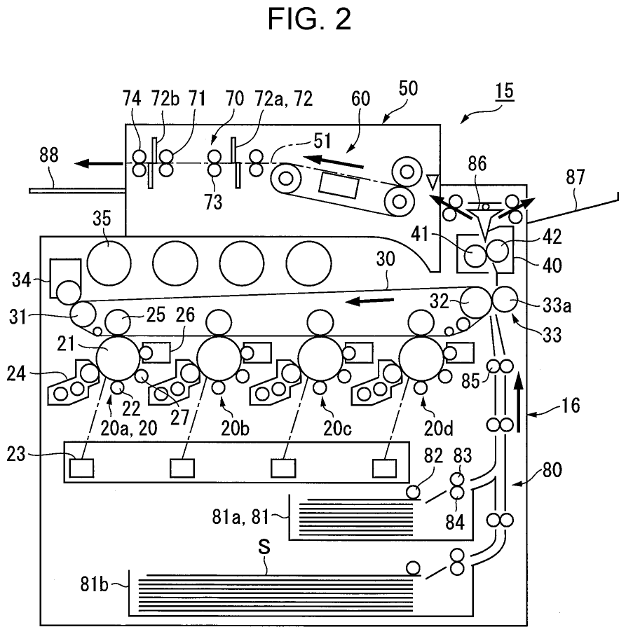

FIG. 2 illustrates the overall configuration of an image forming system according to a first exemplary embodiment.

### —Overall Configuration of Image Forming System—

In FIG. 2, an image forming system 15 includes a device body 16 containing an image forming unit that can form color images. A postprocessing device 50, which is an optional device, is additionally provided on the top of the device body 16. Multiple medium supply containers 81 (81a, 81b) that supply a medium, such as sheets, are provided in the bottom side of the device body 16 so as to be pulled out of the device body 16.

### —Image Forming Unit—

An image forming unit used in the first exemplary embodiment utilizes an electrophotographic system, for example, and includes multiple image formers 20. The image formers 20 form four colors of images (yellow (Y), magenta (M), cyan (C), and black (K)), for example. In this example, the image formers 20 (20a through 20d) are arranged side by side along a belt-like intermediate transfer body 30, that is, they are formed in what is known as a tandem structure. For example, multiple colors of toner images formed by the individual image formers 20 (20a through 20d) are sequentially transferred onto the intermediate transfer body 30 (this is called a first transfer operation) and are superimposed on each other. After the superimposed toner images are transferred together onto a medium S transported from the medium supply container 81, they are fixed on the medium S. The image formers 20 may not necessarily be arranged in order of Y, M, C, and K, and may be arranged in a different order.

### (Image Former)

The image formers 20 (20a through 20d) in the first exemplary embodiment each include a photoconductor 21, which serves as an image carrier that forms and carries a toner image of a corresponding color component. Around the photoconductor 21, a charger 22, an exposure device 23, a developing device 24, a first transfer device 25, a photoconductor cleaner 26, and a static eliminator 27, for example, are disposed. The charger 22 is constituted by a charging roller, for example, that charges the photoconductor 21. The exposure device 23 is constituted by a laser scanner or a light emitting diode (LED) array, for example, that forms an electrostatic latent image on the photoconductor 21 charged by the charger 22. The developing device 24 includes a developing roller, for example, which develops an electrostatic latent image formed on the photoconductor 21 by using a toner of a corresponding color. The first transfer device 25 is disposed at a position at which it faces the photoconductor 21 so as to sandwich the intermediate transfer body 30 therebetween. The first transfer device 25 is constituted by a first transfer roller or a corona discharger, for example, that performs the first transfer operation for transferring a toner image on the photoconductor 21 to the intermediate transfer body 30. The photoconductor cleaner 26 includes a cleaning member for cleaning residual toner remaining on the photoconductor 21. The static eliminator 27 is constituted by a static eliminator roller or a corona discharger, for example, for eliminating residual electric charge remaining on the photoconductor 21.

In the first exemplary embodiment, the single exposure device 23 performs an exposure operation for the four image formers 20 (20a through 20d).

### (Intermediate Transfer Body and Second Transfer Device)

The intermediate transfer body 30 is tightly stretched on multiple tension rollers 31 and 32. For example, the tension roller 31 serves as a driving roller, which transports the intermediate transfer body 30. The tension roller 32 serves as a backup roller for a second transfer device 33, for example, and is located to face the second transfer device 33. An intermediate transfer body cleaner 34, which removes residual toner on the intermediate transfer body 30, is also disposed at a position at which it faces the tension roller 31 used for the intermediate transfer body 30.

In this example, the second transfer device 33 includes a second transfer roller 33a that contacts the front side of the intermediate transfer body 30 which faces the tension roller 32. In this example, the second transfer device 33 applies a second transfer electric field to between the second transfer roller 33a and the tension roller 32 so as to transfer images on the intermediate transfer body 30 together onto the medium S (this is called a second transfer operation).

Inside the device body 16, toner boxes 35 are provided above the intermediate transfer body 30 so as to correspond to the developing devices 24 of the individual image formers 20. The individual toner boxes 35 supply toner to the developing devices 24 of the corresponding colors via a transport path, which is not shown.

### (Medium Transport System)

A medium transport system 80 in the first exemplary embodiment is formed as follows. A medium is fed from each medium supply container 81 by a pickup roller 82. Then, the medium is sorted by a feed roller 83 and a retard roller 84 and only one sheet of medium is transported to the transport path on the downstream side. In the transport path, matching rollers 85 and a first fixing unit 40 are provided. The matching rollers 85 determine the position of the medium S carried from the medium supply container 81 before the medium S enters the second transfer device 33. The first fixing unit 40 fixes an unfixed toner image transferred onto the medium S by the second transfer device 33. A switching member 86, which switches the transport path, is provided on the downstream side of the first fixing unit 40. In this example, the switching member 86 switches the transport path between two directions, which are toward the postprocessing device 50 and toward a first output receiver 87. The first output receiver 87 stores a medium directly output from the device body 16.

As the medium supply container 81, two medium supply containers 81a and 81b that store different sizes of sheets of medium are shown by way of example. However, this is only an example, and three or more medium supply containers 81 may be provided, or only one medium supply container 81 may be provided. A manual feeder, which is not shown, may be provided, and a medium may be fed from the manual feeder to the transport path.

### (First Fixing Unit)

The first fixing unit 40 in the first exemplary embodiment includes a heating fixing roller 41 and a pressurizing fixing roller 42, for example. The heating fixing roller 41 has a built-in heat source, such as a halogen lamp, which is not shown. The pressurizing fixing roller 42 is disposed to face the heating fixing roller 41 and transports a medium by sandwiching it to a fixing area formed between the pressurizing fixing roller 42 and the heating fixing roller 41. With this configuration, when a medium having an unfixed toner image held thereon passes through the fixing area of the first fixing unit 40, the unfixed toner image is fixed onto the medium by the application of heat and pressure.

In this example, a pair of a heating roller and a pressurizing roller is used for the first fixing unit 40. However, the first fixing unit 40 is not limited to this configuration, and suitable members can be selected. For example, a medium may be held in a fixing area formed between a heating fixing roller and a pressurizing fixing belt, and an unfixed image on the medium may be fixed by the application of heat and pressure. In this case, a pressurizing pad is provided to face the heating fixing roller, and the pressurizing fixing belt is interposed between the heating fixing roller and the pressurizing pad. In this example, the pressurizing fixing belt is rotated by the rotation of the heating fixing roller.

### —Configuration Example of Postprocessing Device—

As illustrated in FIG. 2, the postprocessing device 50 includes a second fixing unit 60 and a cutting device 70. The second fixing unit 60 is provided in a mid-portion of a medium transport path 51 and processes a toner image surface of a medium into a high-gloss surface. The cutting device 70 cuts a medium having passed through the second fixing unit 60. In the first exemplary embodiment, a second output receiver 88 is provided on the downstream side of the postprocessing device 50 and stores a medium having passed through the cutting device 70.

Before giving a detailed explanation of the second fixing unit 60, the cutting device 70 will first be explained below.

### —Cutting Device—

In the first exemplary embodiment, the cutting device 70 can cut sides of a medium and form a borderless print sheet, for example. To implement this purpose, as shown in FIG. 2, the cutting device 70 includes a slitter 71 and circular cutters 72 (72a, 72b). The slitter 71 is a member which cuts a medium along the width, while the circular cutter 72 is a member which cuts the medium along the length in the feeding direction. The cutting device 70 also includes multiple transport rollers 73 and 74 to transport a medium.

In this example, the slitter 71 has a required number of blades in the axial direction in accordance with the number of pieces to be produced by cutting a medium and cuts the medium in the feeding direction while transporting it. The circular cutter 72 temporarily stops the transportation of a medium and then cuts the medium by moving a rolling cutter having an upper blade along a lower blade. As the circular cutter 72, a roller cutter may be provided in the axial direction and cut a medium while transporting it.

The cutting device 70 has, not only a function of cutting a medium into multiple (four, for example) pieces, but also other functions. As an example of the other functions of the cutting device 70, one L-size (standard photo size in Japan, which is equivalent to 3R size (standard photo size in the United States)) image is printed on a postcard-size medium (100×150 mm), and the cutting device 70 can finish the medium as a borderless print sheet. As another example of the other functions of the cutting device 70, a desired number of L-size (3R-size) images, such as photographic images using a digital camera, can be obtained. For example, four images are printed on an A4-size medium, and then, the four images are printed one by one on a desired number of postcard-size mediums. Additionally, as a result of varying the widthwise position of the blades of the slitter 71, a medium can be cut into various sizes, such as into four pieces, six pieces, and eight pieces.

### —Basic Configuration of Second Fixing Unit—

The basic configuration of the second fixing unit 60 is similar to that of the fixing device 10 shown in FIG. 1A.

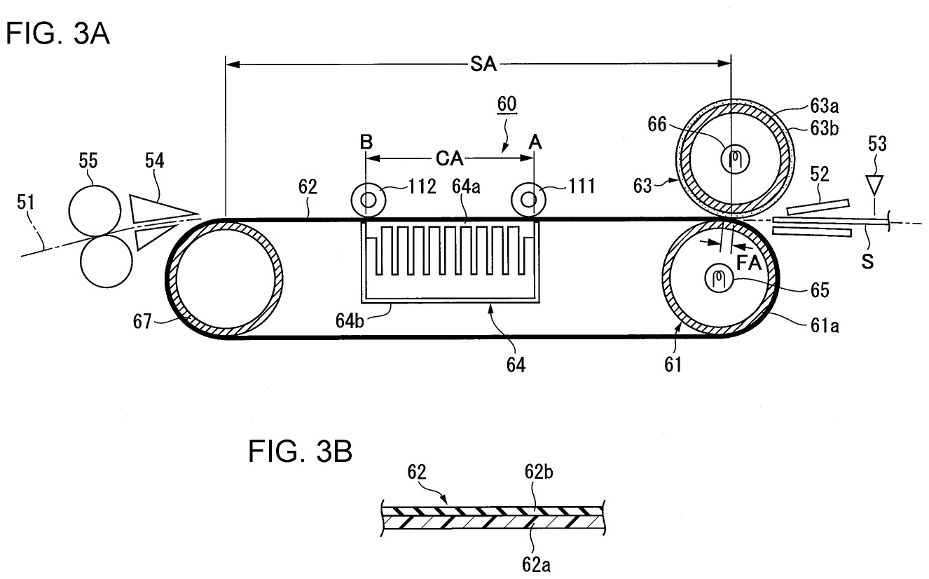

That is, as illustrated in FIGS. 2 and 3A, the second fixing unit 60 includes a heating fixing roller 61, a transport fixing belt 62, a pressurizing fixing roller 63, and a cooling unit 64.

The heating fixing roller 61, which corresponds to the above-described heating fixing unit (see FIG. 1A), includes a built-in heat source 65 in this example. The transport fixing belt 62, which corresponds to the above-described transport fixing unit (see FIG. 1A), is rotatably provided as a result of being tightly stretched on the heating fixing roller 61. The transport fixing belt 62 transports the medium S while contacting the surface of the medium S on which an image is formed. The pressurizing fixing roller 63, which corresponds to the above-described pressurizing fixing unit (see FIG. 1A), is disposed to face the heating fixing roller 61 so as to sandwich the transport fixing belt 62 therebetween. The pressurizing fixing roller 63 is pressed against the heating fixing roller 61 so as to form a fixing area FA therebetween.

The cooling unit 64, which corresponds to the above-described cooling unit (see FIG. 1A), is disposed in a space surrounded by the transport fixing belt 62 and cools the transport fixing belt 62. In this example, the cooling unit 64 is located farther downstream than the fixing area FA in the transport direction of the medium S and is disposed to contact the back side of the transport fixing belt 62 within a medium transport area SA.

### (Heating Fixing Roller)

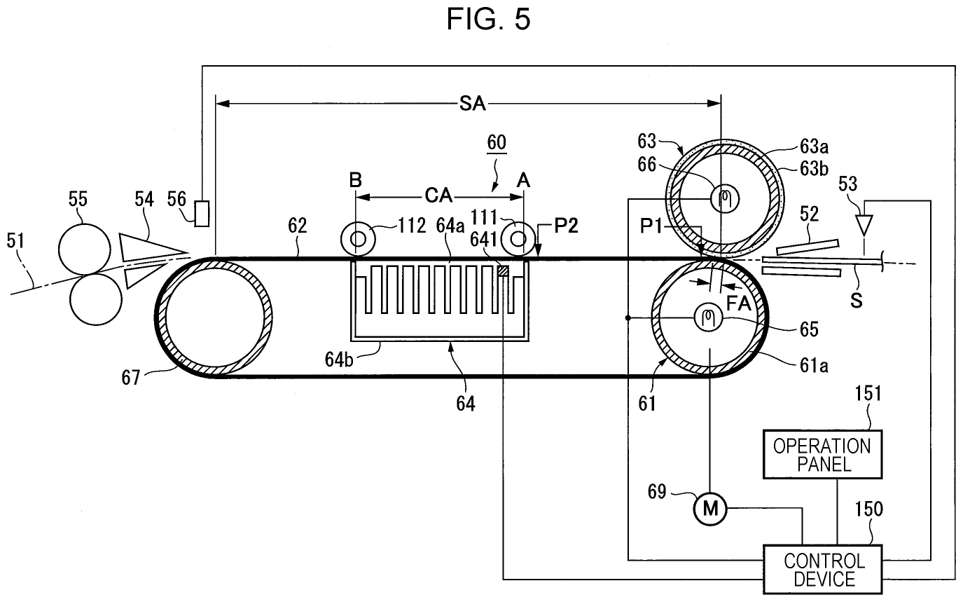

The heating fixing roller 61 is formed by applying a release layer (not shown) constituted by a PFA tube, for example, onto the surface of a metal core 61a having high heat conductivity. A heat source 65, such as a halogen lamp, is provided inside the core 61a. Heating of the heat source 65 is controlled so that the surface of the heating fixing roller 61 has a predetermined temperature. The heating fixing roller 61 is driven to rotate by a drive motor 69 (see FIG. 5) so as to rotate the transport fixing belt 62.

### (Transport Fixing Belt)

As illustrated in FIG. 3B, the transport fixing belt 62 is constituted by an endless film base member 62a made of a thermosetting polyimide resin, for example, coated with a highly smooth coating layer 62b made of fluorine rubber or silicone rubber, for example. As the film base member 62a and the coating layer 62b of the transport fixing belt 62, a base member and a coating layer each having a suitable thickness are selected to maintain the mechanical strength and to efficiently utilize thermal energy. For example, a base member having a thickness of about 75 μm coated with a coating layer having a thickness of about 35 μm is used.

The transport fixing belt 62 is tightly stretched on the heating fixing roller 61 and a separating roller 67 so as to be rotated by the rotation of the heating fixing roller 61.

The separating roller 67 corresponds to the above-described separator (see FIG. 1A) and separates the medium S from the transport fixing belt 62. The separating roller 67 is rotated by following the movement of the transport fixing belt 62. The separating roller 67 tightly supports the transport fixing belt 62 thereon while winding it up so as to cause a sudden change in the moving direction of the transport fixing belt 62. Because of this configuration, at the position of the separating roller 67, the medium S on the transport fixing belt 62 is separated from the transport fixing belt 62 by itself because of the stiffness of the medium S.

The transport fixing belt 62 is tightly stretched on the heating fixing roller 61 and the separating roller 67 in this example. However, the transport fixing belt 62 may be provided in a different manner. For example, a steering roller, which is not shown, may be provided in a region where the transport fixing belt 62 returns from the separating roller 67 to the heating fixing roller 61. In this case, the steering roller presses the transport fixing belt 62 outwardly to maintain the tension of the transport fixing belt 62. The steering roller tilts the rotating axis of oneself to correct the position of the transport fixing belt 62 which is displaced to one side while rotating. The displacement of the transport fixing belt 62 to one side refers to that the transport fixing belt 62 is shifted toward one of the two ends in a direction of the rotating axis of the steering roller.

### (Pressurizing Fixing Roller)

The pressurizing fixing roller 63 is formed such that an elastic layer 63b made of silicone rubber, for example, covers the surface of a metal core 63a having high heat conductivity. A release layer (not shown) similar to that of the heating fixing roller 61 is formed on the surface of the elastic layer 63b. In the first exemplary embodiment, a heat source 66, such as a halogen lamp, is provided inside the core 63a of the pressurizing fixing roller 63. Heating of the heat source 66 is controlled so that the surface of the pressurizing fixing roller 63 has a predetermined temperature. The medium S transported to the second fixing unit 60 passes through the fixing area FA formed between the heating fixing roller 61 and the pressurizing fixing roller 63. At this time, a toner image on the medium S is heated and pressurized in a state in which the toner image surface of the medium S contacts the transport fixing belt 62.

In this example, the pressurizing fixing roller 63 includes the heat source 66. However, the provision of the heat source 66 in the pressurizing fixing roller 63 may be omitted.

### (Cooling Unit)

In the first exemplary embodiment, the cooling unit 64 is provided in a region between the heating fixing roller 61 and the separating roller 67 (this region corresponds to the medium transport area SA) in a state in which it contacts the back side of the transport fixing belt 62. The cooling unit 64 contacts a portion of the medium transport area SA of the transport fixing belt 62 and uses this contact portion as the cooling area CA. In the cooling area CA, the cooling unit 64 cools the transport fixing belt 62 by absorbing heat of the transport fixing belt 62. With this configuration, the medium S, which is transported while closely contacting the transport fixing belt 62, can be cooled.

The cooling unit 64 in the first exemplary embodiment corresponds to a heat sink and includes a fin member 64a and a cover member 64b. The fin member 64a includes many heat dissipating fins extending substantially perpendicular to the surface of the transport fixing belt 62. The cover member 64b is formed in a tubular shape having a rectangular cross section so as to cover the fin member 64a. The cooling unit 64 uses an air blower, which is not shown, to cause air to flow inside, thereby dissipating heat in the fin member 64a to the outside.

A temperature sensor 641 (see FIG. 5) is disposed on part of the fin member 64a, for example. The cooling unit 64 turns the air blower ON or OFF or controls the air volume of the air blower, based on a detection result of the temperature sensor 641.

### (Close-Contact Transportation of Medium)

In the first exemplary embodiment, in terms of securing the cooling effect of the cooling unit 64, the cooling unit 64 is formed as shown in FIG. 3A. That is, in this example, the medium S can be located to closely contact the cooling area CA of the cooling unit 64 while being transported by the transport fixing belt 62.

In this example, an inlet opposing roller 111 is provided on the front side of the transport fixing belt 62 at a portion corresponding to the inlet (upstream start point A) of the cooling area CA of the cooling unit 64. The inlet opposing roller 111 is disposed to contact the transport fixing belt 62 and is rotated by following the movement of the transport fixing belt 62.

An outlet opposing roller 112 is provided on the front side of the transport fixing belt 62 at a portion corresponding to the outlet (downstream end point B) of the cooling area CA of the cooling unit 64. The outlet opposing roller 112 is disposed to contact the transport fixing belt 62 and is rotated by following the movement of the transport fixing belt 62.

In this manner, each of the inlet opposing roller 111 and the outlet opposing roller 112 serves as an opposing rotator.

In this example, the inlet opposing roller 111 is located at a portion corresponding to the inlet of the cooling area CA. By positioning the inlet opposing roller 111 at this portion, the medium S transported by the transport fixing belt 62 is pulled in at the inlet of the cooling area CA so as to closely contact the transport fixing belt 62.

The provision of the outlet opposing roller 112 is effective in closely contacting the medium S to the transport fixing belt 62. More specifically, the outlet opposing roller 112 serves to closely contact the medium S to the transport fixing belt 62, together with the inlet opposing roller 111, at two leading and trailing locations in the transport direction of the medium S. The outlet opposing roller 112 is disposed at a portion corresponding to the outlet of the cooling area CA. However, the position of the outlet opposing roller 112 is not limited to this portion and may be provided farther upstream than the outlet of the cooling area CA.

### (Selection of Medium)

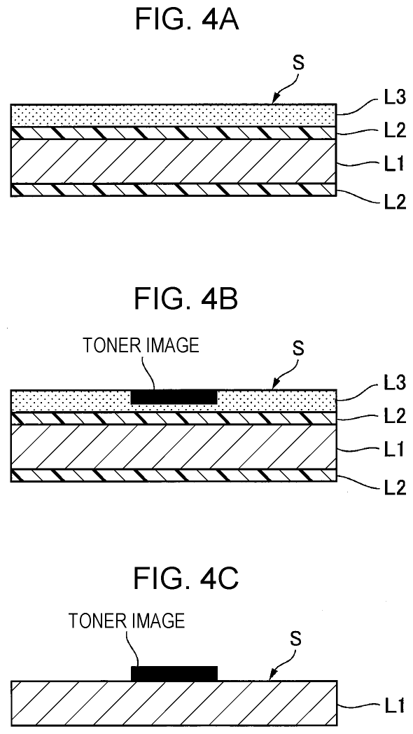

Typically, to obtain a high-gloss image, such as a photographic image, a special sheet, such as that shown in FIG. 4A, may be used as the medium S. In this special sheet, a moisture-proof layer L2 is applied onto each side of a base member layer L1, and an image receiving layer L3 is provided on a recording surface (surface on which a toner image is to be formed) of the moisture-proof layer L2. This structure is similar to that of photographic paper used for a silver halide print, for example.

The moisture-proof layer L2 is made of a resin having no permeability, such as polyethylene, and has a thickness of about several micrometers to exhibit a moisture-proof effect for the base member layer L1. The image receiving layer L3 is made of a thermosetting resin, as a principal component, such as polyester, having a melting temperature of about 130° C. and has a thickness of 5 to 20 μm, and more preferably, about 10 sm. The base member layer L1 has a composition similar to that of plain paper, which is made of cellulose as a principal component. Alternatively, a special base member layer L1 having a composition different from that of plain paper may be used.

As the medium S, therefore, a medium having a moisture-proof layer L2 on each side of a base member layer L1 and having an image receiving layer L3 made of a material similar to a toner material on the recording surface of the moisture-proof layer L2 may be selected. Using such a medium S obtains the following effects.
(1) The medium S does not have permeability and thus prevents some inconveniences, which may be caused if the base member layer L1 absorbs moisture under a high humidity environment. Examples of the inconveniences are the occurrence of curling due to the extension of the base member layer L1 and the occurrence of cracking due to the extension of a toner image.
(2) A toner image can be embedded into the image receiving layer L3 in a good state, thereby obtaining a smooth surface of the printed medium S. This is because a toner image can melt together with the image receiving layer L3 and be embedded into the image receiving layer L3 with the application of pressure.

In a photograph print mode, if the second fixing unit 60 performs a fixing operation using such a special sheet, the resulting toner image is embedded into the image receiving layer L3, as shown in FIG. 4B. At this time, the surface texture of the transport fixing belt 62 of the second fixing unit 60 is reflected, which makes the surface of the image receiving layer L3 and the surface of the toner image substantially uniform, resulting in a high-gloss image. In contrast, in a plain paper print mode, a toner image is fixed on plain paper used as the medium S only with the first fixing unit 40. In this case, as shown in FIG. 4C, the toner image is merely mounted on the base member layer L1 and is projected from the surface of the base member layer L1, resulting in an image having poor gloss characteristics.

### (Peripheral Structure of Second Fixing Unit)

In this example, as illustrated in FIG. 5, near the entrance of the second fixing unit 60, an entrance guiding member 52 is provided to guide the medium S into the entrance of the second fixing unit 60. A position sensor 53 is also provided to detect the position of the leading end or the trailing end of the medium S which is to pass through the transport path 51.

Near the exit of the second fixing unit 60, an exit guiding member 54 is provided to guide the medium S output from the exit of the second fixing unit 60. Transport rollers 55 are provided on the downstream side of the exit guiding member 54.

In this example, to obtain a high-gloss image, the separation temperature Ts of the medium S at the separation position of the second fixing unit 60 is adjusted to be a predetermined threshold temperature or lower. To adjust the temperature Ts of the medium S, a contactless temperature sensor 56 is disposed near the separation position of the second fixing unit 60 and measures the temperature Ts of the medium S at the separation position. As the temperature sensor 56, a radiation thermometer is used.

### —Control System of Second Fixing Unit—

In this example, as illustrated in FIG. 5, the control system of the second fixing unit 60 includes a control device 150 constituted by a microcomputer including various processors. The term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

An operation panel 151 of the image forming system 15 is connected to the control device 150. In the operation panel 151, a start switch (SW) for causing the control device 150 to start processing for forming an image on the medium S, a mode switch (SW) for selecting an image forming mode, such as single-sided printing, double-sided printing, or high-definition printing, and a medium type specifier for specifying a medium type to be used, for example, are provided.

In a read only memory (ROM), which serves as a storage of the control device 150, programs for controlling the second fixing unit 60 are preinstalled. These programs include a program for executing power supply processing for controlling power supply to the second fixing unit 60 and a program for executing processing for individual operation modes of the second fixing unit 60. The processing for individual operation modes includes fixing processing for the regular operation mode and waiting processing for the standby mode.

In this example, in the power supply processing, the amount of heating power to be supplied to the second fixing unit 60 is controlled in accordance with the operation mode of the second fixing unit 60. In this example, the normal amount of heating power is supplied in the regular operation mode, while the supply of heating power is interrupted or the supply amount of heating power is reduced during the standby mode.

The fixing processing for the regular operation mode includes heating and pressurizing processing performed in the fixing area FA for the medium S transported by the transport fixing belt 62 and cooling processing performed by the cooling unit 64.

The waiting processing for the standby mode is processing for causing the transport fixing belt 62 to wait when the supply of heating power to the second fixing unit 60 is interrupted or reduced. In this example, as the waiting processing, the transport fixing belt 62 is driven to perform idling rotation so as to suppress a temperature drop of a heated portion of the transport fixing belt 62 during the standby mode.

Various detectors, such as the position sensor 53 and the temperature sensors 56 and 641, are connected to the control device 150. Various control targets, such as the drive motor 69 and the heat sources 65 and 66, are also connected to the control device 150.

The processor of the control device 150 receives an instruction signal from the operation panel 151 and detection signals from various detectors, executes the above-described programs, and sends suitable control signals to the control targets.

### —Basic Operation of Image Forming System—

The basic operation of the image forming system 15 will now be described below.

As shown in FIG. 2, the individual colors of toner images formed by the image formers 20 (20a through 20d) are transferred onto the intermediate transfer body 30 in the first transfer operation and are transported to a second transfer region. The superimposed toner images held on the intermediate transfer body 30 are transferred together onto the medium S fed from the medium supply container 81 by the second transfer device 33 in the second transfer operation.

The unfixed toner images transferred onto the medium S together are fixed by the first fixing unit 40. Then, the medium S having the fixed toner image thereon is guided to the first output receiver 87 or to the second output receiver 88 via the postprocessing device 50 by the switching member 86.

In the first exemplary embodiment, the switching member 86 switches the medium transport direction in the following manner. The switching member 86 switches the medium transport direction in accordance with whether the plain paper print mode or the photograph print mode is used. The plain paper print mode is a mode in which a regular image, that is, a low-gloss print sheet, is formed. The photograph print mode is a mode in which a high-gloss image, such as a photographic image, that is, a high-gloss print sheet, is formed.

In the plain paper print mode, the medium S subjected to the fixing operation by the first fixing unit 40 is output to the first output receiver 87 by the switching member 86. In the photograph print mode, the medium S subjected to the fixing operation by the first fixing unit 40 is output to the second fixing unit 60 by the switching member 86. Then, the medium S is subjected to the fixing operation by the second fixing unit 60 and is output to the second output receiver 88 via the cutting device 70. The cutting device 70 can be used when a borderless print sheet, such as a photographic image, is to be output, for example. If it is not necessary to cut the medium S, the medium S is simply output to the second output receiver 88 without using the cutting device 70.

Typically, to obtain a high-gloss image, such as a photographic image, a special sheet, such as that shown in FIG. 4A, may be used as the medium S.

In the photograph print mode, when the second fixing unit 60 performs a fixing operation using such a special sheet, the resulting toner image is embedded into the image receiving layer L3, as shown in FIG. 4B. At this time, the surface texture of the transport fixing belt 62 of the second fixing unit 60 is reflected, which makes the surface of the image receiving layer L3 and the surface of the toner image substantially uniform, resulting in a high-gloss image.

### —Regular Operation Mode of Second Fixing Unit—

In the regular operation mode, the fixing operation of the second fixing unit 60 is performed as follows.

The medium S guided to the postprocessing device 50 via the first fixing unit 40 is about to enter the second fixing unit 60, as shown in FIG. 3A. In this state, in the second fixing unit 60, the heating fixing roller 61 and the pressurizing fixing roller 63 are respectively heated by the heat sources 65 and 66 to the temperatures at which they can fix a toner image onto the medium S. The transport fixing belt 62 is rotating in accordance with the rotation of the heating fixing roller 61.

The cooling unit 64 is in the standby state to perform a cooling operation by driving the air blower.

In this state, the medium S is heated and pressurized in the fixing area FA and is then transported by the transport fixing belt 62. Then, the heated medium S is cooled by the cooling unit 64 and is then separated at the separation position of the second fixing unit 60.

In this manner, the medium S undergoes a series of fixing processing, that is, heating and pressurizing processing and then cooling processing, in the second fixing unit 60. As a result, with the use of a special sheet, such as that shown in FIG. 4A, a high-gloss image, such as a photographic image, can be obtained.

### —Standby Mode of Second Fixing Unit—

### (Need of Standby Mode)

In the first exemplary embodiment, the image forming system 15 includes two fixing units, that is, the first fixing unit 40 and the second fixing unit 60. Since the first fixing unit 40 and the second fixing unit 60 each include a heat source, a sufficient amount of heating power is required for starting (warming-up) the first fixing unit 40 and the second fixing unit 60. In such a situation, the upper limit of allowable power that can be used by the first fixing unit 40 and the second fixing unit 60 at the same time is usually determined for the image forming system 15. To start the first fixing unit 40 and the second fixing unit 60 together, heating power is supplied to each of the first fixing unit 40 and the second fixing unit 60 at the same time. In this case, a sufficiently large amount of power is supplied to the first fixing unit 40 and the second fixing unit 60, which may exceed the upper limit of allowable power. To avoid such a situation, mutually exclusive control may be performed for the supply of heating power to the first fixing unit 40 and the second fixing unit 60. Mutually exclusive control is a control method such that, when heating power is supplied to one of the first fixing unit 40 and the second fixing unit 60, the supply of heating power to the other one of the first fixing unit 40 and the second fixing unit 60 is interrupted. For example, the second fixing unit 60, which takes more time for warming-up, is first started, and the first fixing unit 40, which takes less time for warming-up, is started later. While the first fixing unit 40 is being started, the supply of heating power to the second fixing unit 60 is interrupted and the second fixing unit 60 enters the standby mode to prepare for the regular operation.

In this example, when the supply of heating power to one of the first fixing unit 40 and the second fixing unit 60 is not interrupted but is reduced, too, this fixing unit is shifted to the standby mode.

The supply of heating power to the second fixing unit 60 is reduced in the following case, for example. When the image forming system 15 is in the plain paper print mode, for example, only the first fixing unit 40 is used. If the second fixing unit 60 is driven as in the regular operation mode, the transport fixing belt 62 is rotated wastefully and is repeatedly heated and cooled, thereby wasting power. In this example, therefore, the supply of heating power to the second fixing unit 60 is reduced, and the second fixing unit 60 enters the standby mode. With a reduced amount of heating power supplied to the second fixing unit 60 during the standby mode, power is consumed less than that in the regular operation mode.

Typically, during the standby mode, the transport fixing belt 62 is driven to perform idling rotation in a predetermined direction. With this method, however, when the supply of heating power is interrupted or reduced, the temperature of the transport fixing belt 62 is lowered. More specifically, the transport fixing belt 62 is cooled by the cooling unit 64, and the cooled transport fixing belt 62 contacts the heating fixing roller 61 and lowers the temperature of the heating fixing unit 61, too. When the operation mode is returned from the standby mode to the regular operation mode, a larger amount of heating power is required for the second fixing unit 60.

### (Operation Example of Second Fixing Unit in Standby Mode)

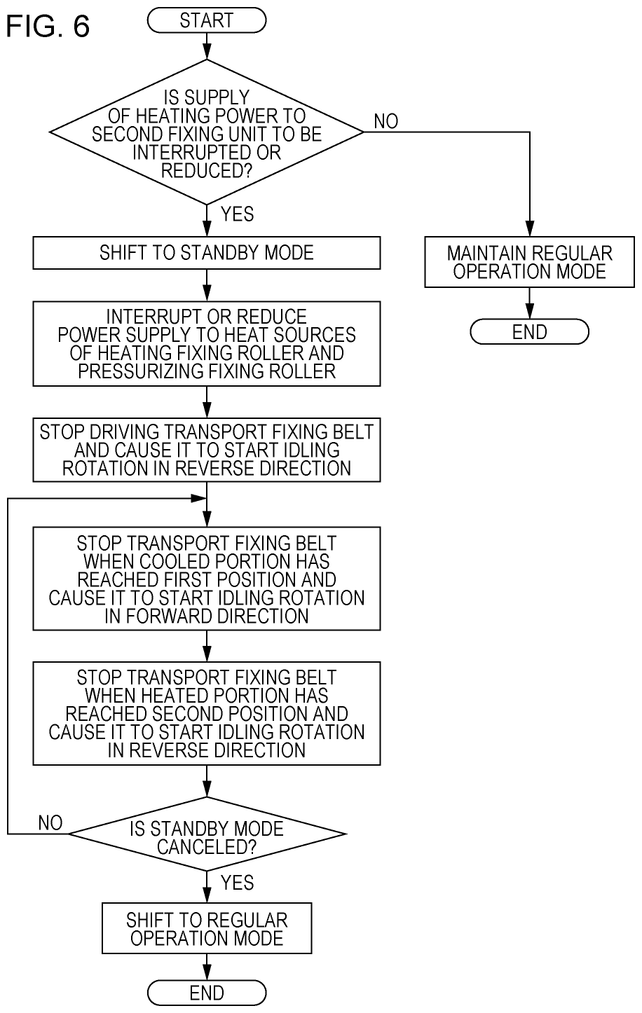

Drive control processing for the second fixing unit 60 during the standby mode will be described below with reference to the flowchart of FIG. 6.

In FIG. 6, it is first determined whether the supply of heating power to the second fixing unit 60 is to be interrupted or reduced. If the supply of heating power to the second fixing unit 60 is not to be interrupted or reduced, the second fixing unit 60 maintains the regular operation mode.

If the supply of heating power to the second fixing unit 60 is to be interrupted or reduced, the second fixing unit 60 shifts to the standby mode.

Then, in this example, the control device 150 interrupts or reduces power supply to the heat source 65 of the heating fixing roller 61 and the heat source 66 of the pressurizing fixing roller 63.

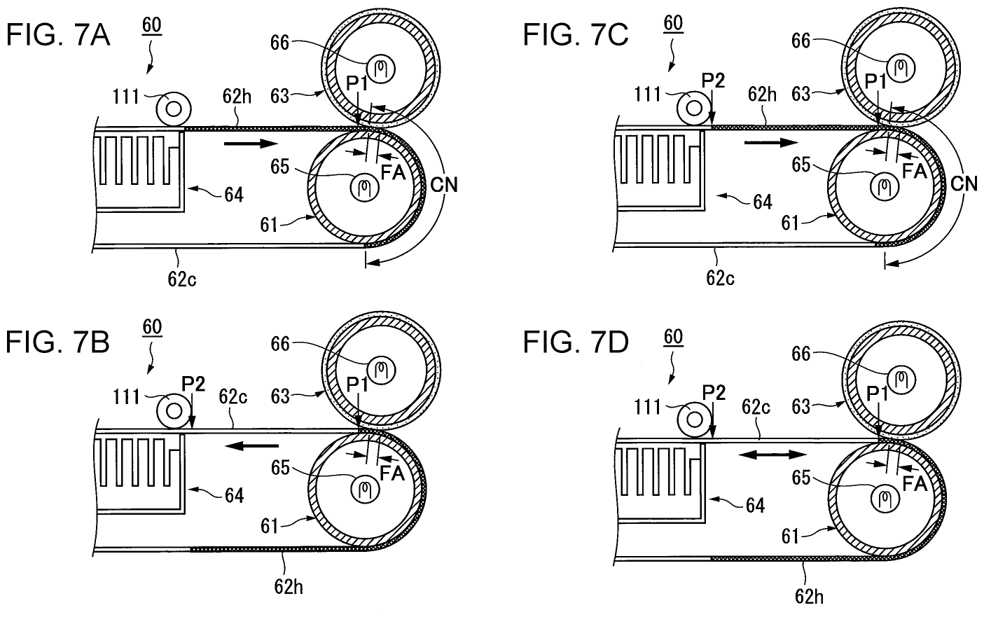

The control device 150 also stops driving the transport fixing belt 62 and causes it to start idling rotation in the reverse direction, as shown in FIG. 7A.

In this state, the heating fixing roller 61 is driven to rotate in the reverse direction and the transport fixing belt 62 is rotated and moved in the reverse direction. At this time, the transport fixing belt 62 includes a cooled portion 62c cooled by the cooling unit 64, as well as a heated portion 62h.

The heated portion 62h includes the contact area CN where the transport fixing belt 62 contacts the heating fixing roller 61 and the area of the transport fixing belt 62 which has been heated by the heating fixing roller 61 and which has not yet reached the cooling unit 64. The cooled portion 62c is a portion of the transport fixing belt 62 other than the heated portion 62h. More specifically, the cooled portion 62c is constituted by a portion of the transport fixing belt 62 which is passing through the cooling area CA of the cooling unit 64 and a portion which has passed through the cooling area CA.

In FIGS. 7A through 7D, the heated portion 62h of the transport fixing belt 62 is indicated by a cross hatch pattern, while the cooled portion 62c is left blank.

Then, the control device 150 stops the transport fixing belt 62 when the cooled portion 62c has reached the first position P1, as illustrated in FIG. 7B. As the first position, a position right before the position at which the cooled portion 62c reaches the contact area CN (see FIG. 7A) is selected. The control device 150 has stored distance information J1 of the distance from the inlet of the cooling area CA of the cooling unit 64 to the first position P1. Based on the distance information J1, the control device 150 drives the heating fixing roller 61 to rotate in the reverse direction and then stops the rotation so as to move the transport fixing belt 62 by a predetermined distance.

In this state, the cooled portion 62c of the transport fixing belt 62 remains at the first position P1 and does not reach the contact area CN. It is thus unlikely that the temperature of the heating fixing roller 61 and that of the pressurizing fixing roller 63 are lowered by the cooled portion 62c.

In accordance with the rotation and the movement of the transport fixing belt 62 in the reverse direction, the heated portion 62h is moved to reach the lower belt portion of the transport fixing belt 62. When the transport fixing belt 62 has stopped moving, the heated portion 62h extends to the outside of the contact area CN.

Then, the control device 150 drives the transport fixing belt 62 to perform idling rotation in the forward direction, as shown in FIG. 7B. The heating fixing roller 61 is driven to rotate in the forward direction, which rotates and moves the transport fixing belt 62 in the forward direction.

Then, the control device 150 stops the transport fixing belt 62 when the heated portion 62h has reached the second position P2. As the second position, a position right before the position at which the heated portion 62h reaches the cooling area CA is selected. The control device 150 has stored distance information J2 of the distance from the first position P1 to the second position P2. Based on the distance information J2, the control device 150 drives the heating fixing roller 61 to rotate in the forward direction and then stops the rotation so as to move the transport fixing belt 62 by a predetermined distance.

In this state, the heated portion 62h of the transport fixing belt 62 remains at the second position P2 and does not reach the cooling area CA. It is thus unlikely that the temperature of the heated portion 62h is lowered by the cooling unit 64.

In accordance with the rotation and the movement of the transport fixing belt 62 in the forward direction, the heated portion 62h, which extends to the outside of the contact area CN in the lower belt portion of the transport fixing belt 62, is moved in the forward direction. The lower belt portion of the transport fixing belt 62 includes the cooled portion 62c next to the heated portion 62h extending to the outside of the contact area CN. In this example, however, this cooled portion 62c does not reach the contact area CN. This will be explained below in detail. The amount by which the transport fixing belt 62 is shifted in the forward direction is based on the distance information J2 of the distance between the first position P1 and the second position P2. In contrast, the length of the heated portion 62h extending to the outside of the contact area CN is based on the distance information J1 of the distance between the inlet of the cooling area CA and the first position P1. The distance indicated by the distance information J1 is longer than that of the distance information J2 by the length between the inlet of the cooling area CA and the second position P2. Hence, when the heated portion 62h extending to the outside of the contact area CN is moved in the forward direction, the cooled portion 62c does not reach the contact area CN. It is thus unlikely that the temperature of the heating fixing roller 61 is lowered by the cooled portion 62c of the transport fixing belt 62.

Then, the control device 150 drives the transport fixing belt 62, whose heated portion 62h is stopped at the second position P2, to perform idling rotation in the reverse direction, as shown in FIG. 7C. At this time, the control device 150 drives the heating fixing roller 61 to rotate in the reverse direction and then stops the rotation, based on the distance information J2. Then, the transport fixing belt 62 is rotated in the reverse direction and is stopped when the cooled portion 62c has reached the first position P1.

In this manner, thereafter, as illustrated in FIG. 7D, the control device 150 drives the transport fixing belt 62 to repeatedly perform idling rotation in the forward direction and in the reverse direction, by using the first position P1 and the second position P2 as the reference positions to stop the transport fixing belt 62.

In this manner, idling rotation of the transport fixing belt 62 in the forward direction and in the reverse direction is performed so that the heated portion 62h of the transport fixing belt 62 contacts the heating fixing roller 61. The heated portion 62h does not reach the cooling area CA of the cooling unit 64 and the temperature of the heated portion 62h is not unnecessarily lowered. Hence, the temperature of the heating fixing roller 61 and that of the pressurizing fixing roller 63 are not lowered by the idling rotation of the transport fixing belt 62.

To put it another way, idling rotation of the transport fixing belt 62 in the forward direction and in the reverse direction is performed so that the cooled portion 62c of the transport fixing belt 62 does not reach the contact area CN. The heating fixing roller 61 is thus prevented from being cooled by the cooled portion 62c. The temperature of the heating fixing roller 61 is not unnecessarily lowered.

Idling rotation of the transport fixing belt 62 in the forward direction and in the reverse direction is repeatedly performed until the standby mode is canceled.

In this example, examples of the case where the standby mode of the second fixing unit 60 is canceled as follows:
(1) when the first fixing unit 40 has shifted to the standby mode; and
(2) when a medium S to be fixed by the second fixing unit 60 has been transported and passed through a predetermined position.

When the standby mode is canceled, the control device 150 returns the second fixing unit 60 to the regular operation mode.

### Modified Example

In the first exemplary embodiment, during the standby mode, the transport fixing belt 62 performs forward and reverse idling rotation by using the first position P1 and the second position P2 as the reference positions to stop the transport fixing belt 62.

However, idling rotation of the transport fixing belt 62 during the standby mode is not limited to this configuration and may be modified as in the following modified example.

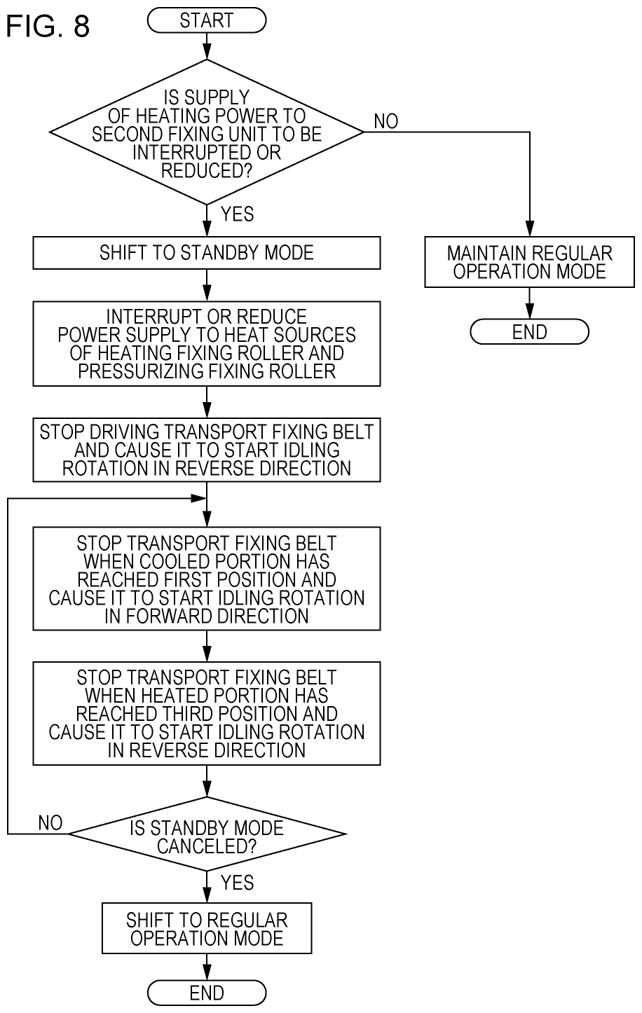

FIG. 8 is a flowchart illustrating drive control processing for the second fixing unit 60 according to a modified example of the first exemplary embodiment.

In FIG. 8, if the supply of heating power to the second fixing unit 60 is not to be interrupted or reduced, the second fixing unit 60 maintains the regular operation mode.

If the supply of heating power to the second fixing unit 60 is to be interrupted or reduced, the second fixing unit 60 shifts to the standby mode.

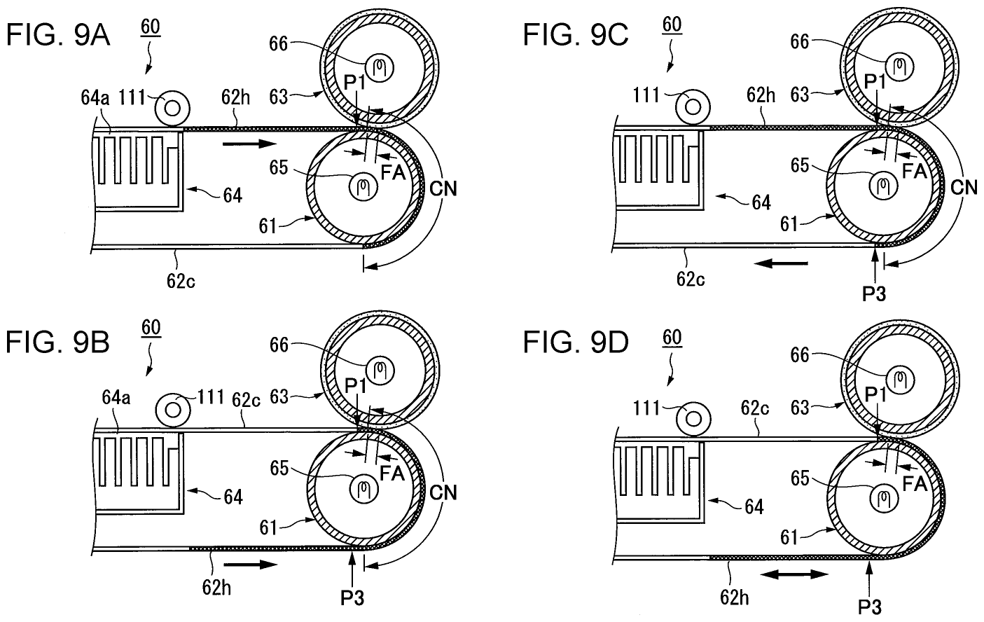

After the second fixing unit 60 has shifted to the standby mode, the control device 150 first executes the following processing operations (1) through (4) in a manner similar to the first exemplary embodiment.
(1) Power supply to the heat source 65 of the heating fixing roller 61 and the heat source 66 of the pressurizing fixing roller 63 is interrupted or reduced.
(2) Driving of the transport fixing belt 62 is stopped and the transport fixing belt 62 is driven to start idling rotation in the reverse direction (see FIG. 9A).
(3) The rotation of the transport fixing belt 62 is stopped when the cooled portion 62c has reached the first position P1 (see FIG. 9B). At this time, in the upper belt portion of the transport fixing belt 62, the cooled portion 62c remains at the first position P1 and does not reach the contact area CN beyond the first position P1. In the lower belt portion of the transport fixing belt 62, when the transport fixing belt 62 has stopped moving, the heated portion 62h extends to the outside of the contact area CN.
(4) The transport fixing belt 62 is driven to start idling rotation in the forward direction (see FIG. 9B).

In FIGS. 9A through 9D, the heated portion 62h of the transport fixing belt 62 is indicated by a cross hatch pattern, while the cooled portion 62c is left blank.

Then, unlike the first exemplary embodiment, the control device 150 stops the transport fixing belt 62 when the cooled portion 62c has reached a third position P3 in the lower belt portion of the transport fixing belt 62. As the third position P3, a position before the position at which the cooled portion 62c cooled by the cooling unit 64 reaches the contact area CN is selected. The control device 150 has stored distance information J3 of the distance from the forward end of the heated portion 62h extending to the outside of the contact area CN to the third position P3. The distance from the forward end of the heated portion 62h extending to the outside of the contact area CN to the contact area CN corresponds to the distance indicated by the distance information J1. The distance information J3 is calculated from the distance information J1 and the position information of the third position P3. In this example, the distance indicated by the distance information J3 is shorter than that of the distance information J1 by the length between the third position P3 and the contact area CN.

Based on the distance information J3, the control device 150 drives the heating fixing roller 61 to rotate in the forward direction and then stops the rotation so as to move the transport fixing belt 62 by a predetermined distance.

In this state, in the lower belt portion of the transport fixing belt 62, the cooled portion 62c remains at the third position P3 and does not reach the contact area CN beyond the third position P3. It is thus unlikely that the temperature of the heating fixing roller 61 is lowered by the cooled portion 62c.

When the transport fixing belt 62 is rotated and moved in the forward direction, the heated portion 62h in the upper belt portion of the transport fixing belt 62 is shifted in the forward direction. In this example, since the distance indicated by the distance information J3 is shorter than that of the distance information J1, the heated portion 62h does not reach the cooling area CA of the cooling unit 64. It is thus unlikely that the temperature of the heated portion 62h of the transport fixing belt 62 is lowered by the cooling area CA.

Then, the control device 150 drives the transport fixing belt 62, whose cooled portion 62c remains at the third position P3, to perform idling rotation in the reverse direction, as shown in FIG. 9C. At this time, the control device 150 drives the heating fixing roller 61 to rotate in the reverse direction and then stops the rotation, based on the distance information J3. Then, the transport fixing belt 62 is rotated in the reverse direction and is stopped when the cooled portion 62c has reached the first position P1.

In this manner, thereafter, as illustrated in FIG. 9D, the control device 150 drives the transport fixing belt 62 to repeatedly perform forward and reverse idling rotation by using the first position P1 and the third position P3 as the reference positions to stop the transport fixing belt 62.

In this example, forward and reverse idling rotation of the transport fixing belt 62 is performed so that the heated portion 62h of the transport fixing belt 62 does not contact the cooling area CA. Accordingly, the heated portion 62h does not reach the cooling area CA of the cooling unit 64 and the temperature of the heated portion 62h is not unnecessarily lowered.

To put it another way, forward and reverse idling rotation of the transport fixing belt 62 is performed so that the cooled portion 62c of the transport fixing belt 62 does not touch the contact area CN. The heating fixing roller 61 is thus prevented from being cooled by the cooled portion 62c. The temperature of the heating fixing roller 61 is not unnecessarily lowered.

Forward and reverse idling rotation of the transport fixing belt 62 is repeatedly performed until the standby mode is canceled, as in the first exemplary embodiment.

When the standby mode is canceled, the control device 150 returns the second fixing unit 60 to the regular operation mode, as in the first exemplary embodiment.

### Second Exemplary Embodiment

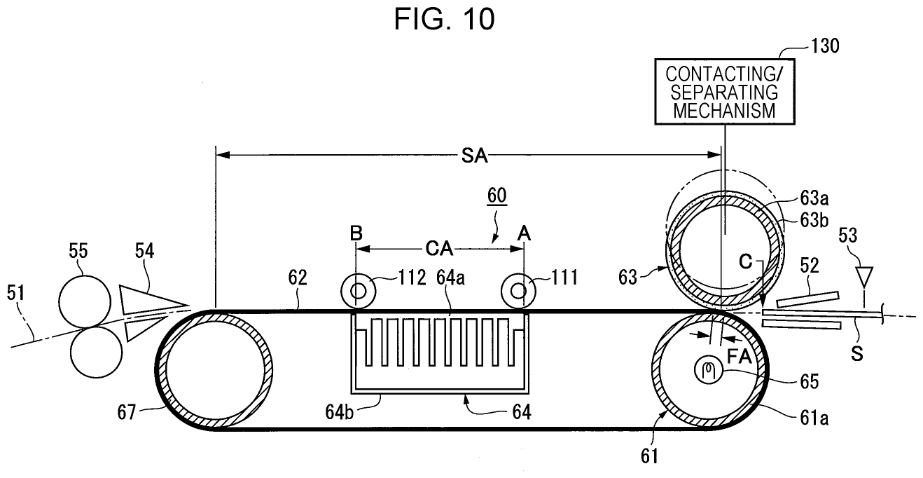

FIG. 10 illustrates the major part of a second fixing unit 60 according to a second exemplary embodiment.

In FIG. 10, the basic configuration of the second fixing unit 60 according to the second exemplary embodiment is similar to that of the first exemplary embodiment. In the second exemplary embodiment, however, control processing executed during the standby mode is partially different from that of the first exemplary embodiment because of a difference in the configuration of the pressurizing fixing roller 63. Elements similar to those of the first exemplary embodiment are designated by like reference numerals and a detailed explanation thereof will be omitted.

In this example, the second fixing unit 60 includes a heating fixing roller 61, a transport fixing belt 62, a pressurizing fixing roller 63, and a cooling unit 64.

Unlike the first exemplary embodiment, the pressurizing fixing roller 63 does not include a heat source 66 within a core 63a. The pressurizing fixing roller 63 includes a contacting/separating mechanism 130, which serves as a contacting/separating unit that selectively contacts or separates the pressurizing fixing roller 63. The contacting/separating mechanism 130 shifts the pressurizing fixing roller 63 between a contact position and a non-contact position. The contact position is a position at which the pressurizing fixing roller 63 contacts the transport fixing belt 62 in the fixing area FA. The non-contact position is a position at which the pressurizing fixing roller 63 is separated from the transport fixing belt 62. In this example, any suitable member may be used as the contacting/separating mechanism 130 if it can shift the pressurizing fixing roller 63 to the contact position and to the non-contact position. For example, a bearing member of the pressurizing fixing roller 63 is supported by a movable support member, and the position of the movable support member is changed by an eccentric cam member that is rotated by a drive motor.

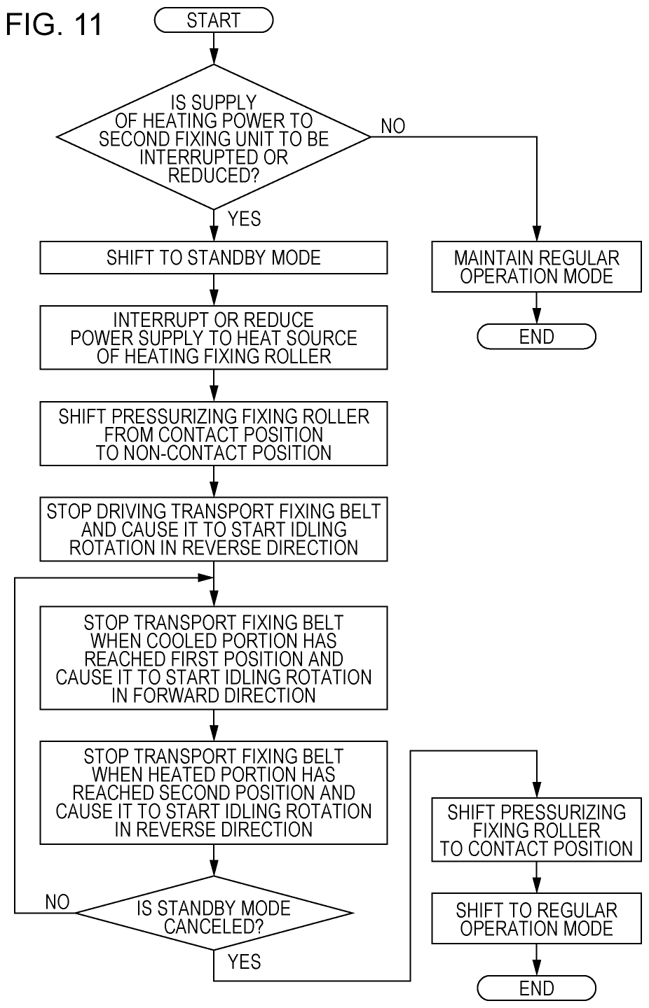

In this example, the control device 150 (see FIG. 5) executes drive control processing for the second fixing unit 60 according to the flowchart of FIG. 11.

If the supply of heating power to the second fixing unit 60 is not to be interrupted or reduced, the second fixing unit 60 maintains the regular operation mode.

If the supply of heating power to the second fixing unit 60 is to be interrupted or reduced, the second fixing unit 60 shifts to the standby mode.

After the second fixing unit 60 has shifted to the standby mode, the control device 150 executes the following processing operations (1) through (7).

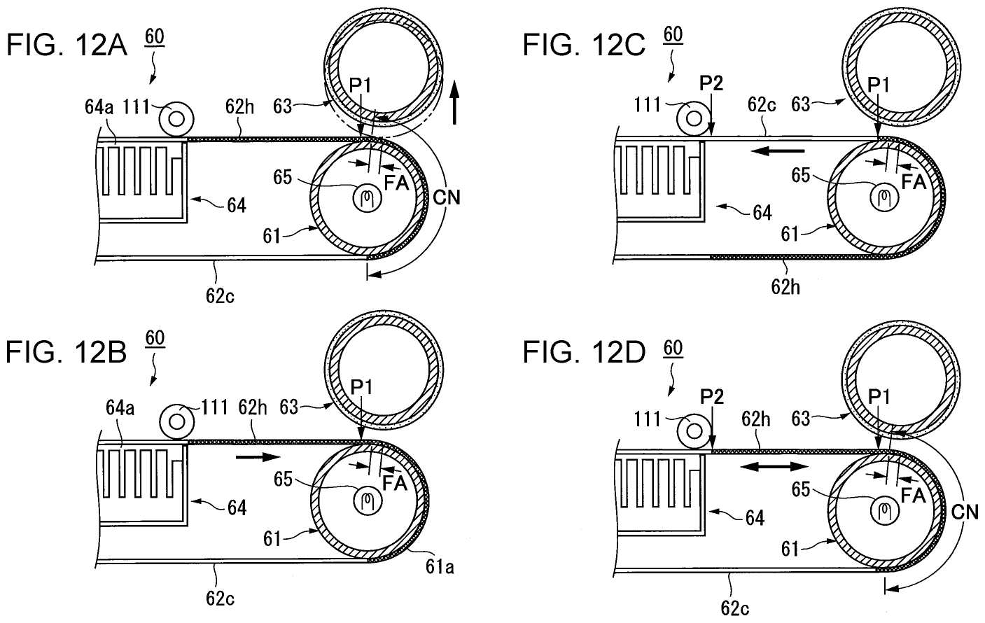

FIGS. 12A through 12D schematically illustrate idling rotation of the second fixing unit 60 during the standby mode. In FIGS. 12A through 12D, the heated portion 62h of the transport fixing belt 62 is indicated by a cross hatch pattern, while the cooled portion 62c is left blank.
(1) Power supply to the heat source 65 of the heating fixing roller 61 is interrupted or reduced.
(2) Driving of the transport fixing belt 62 is stopped and the pressurizing fixing roller 63 is separated from the transport fixing belt 62 and is shifted to the non-contact position (see FIG. 12A).
(3) Then, the transport fixing belt 62 is driven to perform idling rotation in the reverse direction (see FIG. 12B) and is stopped when the cooled portion 62c has reached the first position P1 (see FIG. 12C).

At this time, in the upper belt portion of the transport fixing belt 62, the cooled portion 62c remains at the first position P1 and does not reach the contact area CN beyond the first position P1. The heated portion 62h is passing through the contact area CN while contacting the heating fixing roller 61 but separating from the pressurizing fixing roller 63. Most probably, the temperature of the pressurizing fixing roller 63 without a heat source is lower than that of the heated portion 62h. However, the heated portion 62h does not contact the pressurizing fixing roller 63 and is not cooled by it.

In the lower belt portion of the transport fixing belt 62, when the transport fixing belt 62 has stopped moving, the heated portion 62h extends to the outside of the contact area CN by the distance indicated by the distance information J1.
(4) Then, the transport fixing belt 62 is driven to start idling rotation in the forward direction (see FIG. 12C) and is stopped when the heated portion 62h has reached the second position P2 (see FIG. 12D).

In the upper belt portion, the heated portion 62h is moved in the forward direction by the distance indicated by the distance information J2, which is smaller than that of the distance information J1, and is then stopped. The heated portion 62h remains at the second position P2 and does not reach the cooling area CA beyond the second position P2. The heated portion 62h is moved while contacting the heating fixing roller 61 but separating from the pressurizing fixing roller 63. The heated portion 62h is thus cooled neither by the cooling unit 64 nor the pressurizing fixing roller 63.

In the lower belt portion of the transport fixing belt 62, the heated portion 62h which extends to the outside of the contact area CN is moved in the forward direction by the distance indicated by the distance information J2. Meanwhile, the cooled portion 62c does not reach the contact area CN and is thus prevented from cooling the heating fixing roller 61.
(5) Then, the transport fixing belt 62 is driven to perform idling rotation in the reverse direction and is stopped when the cooled portion 62c has reached the first position P1 (see FIG. 12C).

The heated portion 62h is moved while contacting the heating fixing roller 61 but separating from the pressurizing fixing roller 63. The cooled portion 62c of the transport fixing belt 62 does not contact the heating fixing roller 61.
(6) In this manner, thereafter, as illustrated in FIG. 12D, the control device 150 drives the transport fixing belt 62 to repeatedly perform forward and reverse idling rotation by using the first position P1 and the second position P2 as the reference positions to stop the transport fixing belt 62.

During this idling rotation of the transport fixing belt 62, neither of the cooling unit 64 nor the pressurizing fixing roller 63 cools the heated portion 62h of the transport fixing belt 62. Nor does the cooled portion 62c of the transport fixing belt 62 touch the heating fixing roller 61. Hence, the temperature of the heated portion 62h of the transport fixing belt 62 is not unnecessarily lowered by the heating fixing roller 61.

Forward and reverse idling rotation of the transport fixing belt 62 is repeatedly performed until the standby mode is canceled, as in the first exemplary embodiment.
(7) When the standby mode is canceled, the pressurizing fixing roller 63 is shifted to the contact position, and then, the second fixing unit 60 is returned to the regular operation mode.

In the second exemplary embodiment, forward and reverse idling rotation of the transport fixing belt 62 during the standby mode is performed based on the first position P1 and the second position P2 as the reference positions to stop the transport fixing belt 62. However, as in the modified example of the first exemplary embodiment, the first position P1 and the third position P3 may be used as the reference positions.

### First Example

In a first example, the second fixing unit of the first exemplary embodiment is realized, and a series of drive control processing is executed for the second fixing unit during the standby mode.

In the first example, when heating power to the heating fixing roller is interrupted, the transport fixing belt of the second fixing unit performs idling rotation in the forward and reverse directions within a predetermined range.

In the first example, the transport fixing belt is driven to perform forward and reverse idling rotation in a cycle of two to five seconds such that a heated portion of the transport fixing belt contacts the heating fixing roller.

### First Comparative Example

In a first comparative example, a second fixing unit similarly configured to that of the first example is realized. When heating power to the heating fixing roller is interrupted, the transport fixing belt of this second fixing unit performs idling rotation only in the forward direction.

A series of drive control processing is executed for the second fixing unit of the first example and that of the first comparative example during the standby mode under the following conditions.

The second fixing units of the first example and the first comparative example are started (warmed-up) first, and then, the first fixing units are started. While the first fixing units are being started, the supply of heating power to the second fixing units is interrupted (no power is supplied), and then, the second fixing units are shifted to the standby mode.

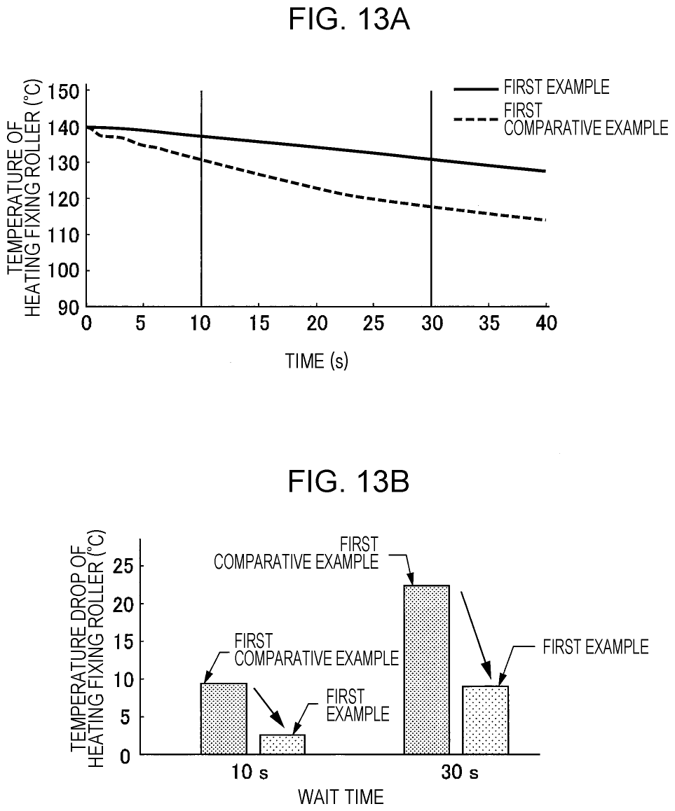

It is now assumed that the initial temperature of the heating fixing roller to perform a fixing operation is set to 140° C., and then, the supply of heating power to the heating fixing roller is interrupted, and the second fixing units are shifted to the standby mode. The relationship between the wait time (selected in a range of 60 seconds) after the supply of heating power is interrupted and the temperature change of the heating fixing roller is examined, and the results shown in FIG. 13A are obtained.

As illustrated in FIG. 13B, the temperature drop of the heating fixing roller of the first example is 2.5° C. after a wait time of 10 seconds and is 9.0° C. after a wait time of 30 seconds.

In contrast, the temperature drop of the heating fixing roller of the first comparative example is 9.5° C. after a wait time of 10 seconds and is 22.5° C. after a wait time of 30 seconds.

It is thus validated that the second fixing unit of the first example can contain a temperature drop to be smaller than that of the first comparative example.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A fixing device comprising:
a heating fixing unit that is rotatable and includes a heat source;
a belt-like transport fixing unit that is rotatably provided as a result of being tightly stretched on the heating fixing unit and that transports a medium having an unfixed image formed thereon while contacting a surface of the medium on which the unfixed image is formed;
a pressurizing fixing unit that is rotatable and is disposed to face the heating fixing unit so as to sandwich the transport fixing unit therebetween and that applies pressure so as to form a fixing area between the pressurizing fixing unit and the heating fixing unit, the fixing area being an area where the unfixed image is fixed;
a cooling unit that cools the transport fixing unit, the cooling unit being disposed in a transport region of the transport fixing unit for the medium so as to contact a back side of the transport fixing unit, the cooling unit being disposed at a position farther downstream than the fixing area in a transport direction of the medium; and
a driving controller that executes drive control during a standby mode to cause the transport fixing unit to perform idling rotation to repeat a forward rotation operation and a reverse rotation operation so that a portion of the transport fixing unit including a contact area where the transport fixing unit contacts the heating fixing unit and an area of the transport fixing unit which has been heated by the heating fixing unit and which has not yet reached a cooling area of the cooling unit contacts the heating fixing unit, the standby mode being a mode in which power supply to the heat source of the heating fixing unit is interrupted or reduced.
   (((2)))

The fixing device according to (((1))), wherein, during the standby mode, the driving controller stops the forward rotation operation of the transport fixing unit and causes the transport fixing unit to start the idling rotation to perform the reverse rotation operation.

(((3)))

The fixing device according to (((2))), wherein, after the transport fixing unit starts the idling rotation to perform the reverse rotation operation, the driving controller stops driving the transport fixing unit when a cooled portion of the transport fixing unit cooled by the cooling unit has reached a first position, the first position being a position at which the cooled portion of the transport fixing unit has not yet reached the contact area, and the driving controller then causes the transport fixing unit to start the idling rotation to perform the forward rotation operation.

(((4)))

The fixing device according to claim (((3))), wherein, after the transport fixing unit starts the idling rotation to perform the forward rotation operation, the driving controller stops driving the transport fixing unit when a heated portion of the transport fixing unit has reached a second position, the second position being a position at which the heated portion of the transport fixing unit has not yet reached a cooling area of the cooling unit, and the driving controller then causes the transport fixing unit to start the idling rotation to perform the reverse rotation operation, and thereafter, the driving controller causes the transport fixing unit to perform the idling rotation to repeat the forward rotation operation and the reverse rotation operation between the first position and the second position.

(((5)))

The fixing device according to (((3))), wherein, after the transport fixing unit starts the idling rotation to perform the forward rotation operation, the driving controller stops driving the transport fixing unit when the cooled portion of the transport fixing unit has reached a third position, the third position being a position at which the cooled portion of the transport fixing unit has not yet reached the contact area, and the driving controller then causes the transport fixing unit to start the idling rotation to perform the reverse rotation operation, and thereafter, the driving controller causes the transport fixing unit to perform the idling rotation to repeat the forward rotation operation and the reverse rotation operation between the first position and the third position.

(((6)))

The fixing device according to one of (((1))) to (((5))), wherein the driving controller causes the transport fixing unit to perform the idling rotation to repeat the forward rotation operation and the reverse rotation operation so that a portion of the transport fixing unit which is passing through the cooling area of the cooling unit and a portion of the transport fixing unit which has passed through the cooling unit do not reach the contact area.

(((7)))

The fixing device according to (((6))), wherein the driving controller causes the transport fixing unit to perform the idling rotation to repeat the forward rotation operation and the reverse rotation operation so that a heated portion of the transport fixing unit heated by the heating fixing unit does not reach the cooling area of the cooling unit.

(((8)))

The fixing device according to one of (((1))) to (((7))), wherein the pressurizing fixing unit includes a contacting/separating unit that shifts the pressurizing fixing unit from a contact position to a non-contact position during the standby mode, the contact position being a position at which the pressurizing fixing unit contacts the transport fixing unit, the non-contact position being a position at which the pressurizing fixing unit is separated from the transport fixing unit.

(((9)))

The fixing device according to (((8))), wherein the pressurizing fixing unit does not include a heat source.

(((10)))

The fixing device according to one of (((1))) to (((9))), further comprising:
a position detector that is disposed on a farther upstream side than the fixing area in the transport direction of the medium and detects a position of a leading end or a trailing end of the medium in the transport direction of the medium,
wherein, based on a detection result of the position detector, the standby mode is canceled and power supply to the heat source of the heating fixing unit is started.
   (((11)))

An image forming system comprising:
an image forming unit that forms an unfixed image on a medium; and
the fixing device according to one of (((1))) to (((10))) that fixes the unfixed image formed on the medium onto the medium.

What is claimed is:

1. A fixing device comprising:
a heating fixing unit that is rotatable and includes a heat source;
a belt-like transport fixing unit that is rotatably provided as a result of being tightly stretched on the heating fixing unit and that transports a medium having an unfixed image formed thereon while contacting a surface of the medium on which the unfixed image is formed;
a pressurizing fixing unit that is rotatable and is disposed to face the heating fixing unit so as to sandwich the transport fixing unit therebetween and that applies pressure so as to form a fixing area between the pressurizing fixing unit and the heating fixing unit, the fixing area being an area where the unfixed image is fixed;
a cooling unit that cools the transport fixing unit, the cooling unit being disposed in a transport region of the transport fixing unit for the medium so as to contact a back side of the transport fixing unit, the cooling unit being disposed at a position farther downstream than the fixing area in a transport direction of the medium; and
a driving controller that executes drive control during a standby mode to cause the transport fixing unit to perform idling rotation to repeat a forward rotation operation and a reverse rotation operation so that a portion of the transport fixing unit including a contact area where the transport fixing unit contacts the heating fixing unit and an area of the transport fixing unit which has been heated by the heating fixing unit and which has not yet reached a cooling area of the cooling unit contacts the heating fixing unit, the standby mode being a mode in which power supply to the heat source of the heating fixing unit is interrupted or reduced.

2. The fixing device according to claim 1, wherein, during the standby mode, the driving controller stops the forward rotation operation of the transport fixing unit and causes the transport fixing unit to start the idling rotation to perform the reverse rotation operation.

3. The fixing device according to claim 2, wherein, after the transport fixing unit starts the idling rotation to perform the reverse rotation operation, the driving controller stops driving the transport fixing unit when a cooled portion of the transport fixing unit cooled by the cooling unit has reached a first position, the first position being a position at which the cooled portion of the transport fixing unit has not yet reached the contact area, and the driving controller then causes the transport fixing unit to start the idling rotation to perform the forward rotation operation.

4. The fixing device according to claim 3, wherein, after the transport fixing unit starts the idling rotation to perform the forward rotation operation, the driving controller stops driving the transport fixing unit when a heated portion of the transport fixing unit has reached a second position, the second position being a position at which the heated portion of the transport fixing unit has not yet reached a cooling area of the cooling unit, and the driving controller then causes the transport fixing unit to start the idling rotation to perform the reverse rotation operation, and thereafter, the driving controller causes the transport fixing unit to perform the idling rotation to repeat the forward rotation operation and the reverse rotation operation between the first position and the second position.

5. The fixing device according to claim 3, wherein, after the transport fixing unit starts the idling rotation to perform the forward rotation operation, the driving controller stops driving the transport fixing unit when the cooled portion of the transport fixing unit has reached a third position, the third position being a position at which the cooled portion of the transport fixing unit has not yet reached the contact area, and the driving controller then causes the transport fixing unit to start the idling rotation to perform the reverse rotation operation, and thereafter, the driving controller causes the transport fixing unit to perform the idling rotation to repeat the forward rotation operation and the reverse rotation operation between the first position and the third position.

6. The fixing device according to claim 1, wherein the driving controller causes the transport fixing unit to perform the idling rotation to repeat the forward rotation operation and the reverse rotation operation so that a portion of the transport fixing unit which is passing through the cooling area of the cooling unit and a portion of the transport fixing unit which has passed through the cooling unit do not reach the contact area.

7. The fixing device according to claim 6, wherein the driving controller causes the transport fixing unit to perform the idling rotation to repeat the forward rotation operation and the reverse rotation operation so that a heated portion of the transport fixing unit heated by the heating fixing unit does not reach the cooling area of the cooling unit.

8. The fixing device according to claim 1, wherein the pressurizing fixing unit includes a contacting/separating unit that shifts the pressurizing fixing unit from a contact position to a non-contact position during the standby mode, the contact position being a position at which the pressurizing fixing unit contacts the transport fixing unit, the non-contact position being a position at which the pressurizing fixing unit is separated from the transport fixing unit.

9. The fixing device according to claim 8, wherein the pressurizing fixing unit does not include a heat source.

10. The fixing device according to claim 1, further comprising:
a position detector that is disposed on a farther upstream side than the fixing area in the transport direction of the medium and detects a position of a leading end or a trailing end of the medium in the transport direction of the medium,
wherein, based on a detection result of the position detector, the standby mode is canceled and power supply to the heat source of the heating fixing unit is started.

11. An image forming system comprising:
an image forming unit that forms an unfixed image on a medium; and
the fixing device according to claim 1 that fixes the unfixed image formed on the medium onto the medium.

12. An image forming system comprising:
an image forming unit that forms an unfixed image on a medium; and
the fixing device according to claim 2 that fixes the unfixed image formed on the medium onto the medium.

13. An image forming system comprising:
an image forming unit that forms an unfixed image on a medium; and
the fixing device according to claim 3 that fixes the unfixed image formed on the medium onto the medium.

14. An image forming system comprising:
an image forming unit that forms an unfixed image on a medium; and
the fixing device according to claim 4 that fixes the unfixed image formed on the medium onto the medium.

15. An image forming system comprising:
an image forming unit that forms an unfixed image on a medium; and
the fixing device according to claim 5 that fixes the unfixed image formed on the medium onto the medium.

16. An image forming system comprising:
an image forming unit that forms an unfixed image on a medium; and
the fixing device according to claim 6 that fixes the unfixed image formed on the medium onto the medium.

17. An image forming system comprising:
an image forming unit that forms an unfixed image on a medium; and
the fixing device according to claim 7 that fixes the unfixed image formed on the medium onto the medium.

18. An image forming system comprising:
an image forming unit that forms an unfixed image on a medium; and
the fixing device according to claim 8 that fixes the unfixed image formed on the medium onto the medium.

19. An image forming system comprising:
an image forming unit that forms an unfixed image on a medium; and
the fixing device according to claim 9 that fixes the unfixed image formed on the medium onto the medium.

20. An image forming system comprising:
an image forming unit that forms an unfixed image on a medium; and
the fixing device according to claim 10 that fixes the unfixed image formed on the medium onto the medium.
